(19) United States
(12) Patent Application Publication
(10) Pub. No.: US 2025/0135672 A1
(43) Pub. Date: May 1, 2025

(54) PROCESS FOR MAKING TAPERED-EDGE ELASTOMERIC SHEETS AND THEIR USE

(71) Applicant: DDP SPECIALTY ELECTRONIC MATERIALS US, LLC, WILMINGTON, DE (US)

(72) Inventor: GERALD F. BILLOVITS, MIDLAND, MI (US)

(21) Appl. No.: 18/917,465

(22) Filed: Oct. 16, 2024

Related U.S. Application Data
(60) Provisional application No. 63/594,131, filed on Oct. 30, 2023.

(51) Int. Cl. B26D 3/02; B26D 1/153; B26D 3/00; B26D 7/00; B26D 7/01

(52) U.S. Cl. CPC B26D 3/02; B26D 1/1535; B26D 3/003; B26D 7/015; B26D 2007/0068; B26D 2210/11

(57) ABSTRACT

Polygonal elastomeric barrier sheets have tapered edges on at least two adjacent sides. At least one of the tapered edges is made by cutting the elastomeric barrier sheet along a cut line at an angle of at most 15° from the plane of the sheet. The elastomeric barrier sheet is supported during the cutting step to prevent distortion due to pressure of the cutting blade. The elastomeric barrier sheet can be supported from above, below or from both above and below, and can be supported on each side of the cut line. The polygonal barrier sheets so produced are useful in building and construction to seal gaps between structural elements such as expansion or control joints in a building or around functional elements such as a window or door inserted into a wall.

### BACKGROUND OF THE INVENTION

The present invention relates to tapered edge elastomeric sheets, methods for making such tapered edge elastomeric sheets, and uses therefor, including as barrier materials for sealing openings between adjacent building structural elements.

Structural elements such as windows and doors are often inserted into rough openings in a building structure. The rough opening is typically somewhat larger than the structural elements being inserted, to allow for easy installation. This produces gaps between the structural element and the building structure. These gaps must be sealed to prevent air and water penetration into the building. This can be done by installing a backer rod and caulking or by installing an insulating foam, but these methods are laborious, require skilled workers, and are unsatisfactory when the gap is large or changes in gap size over time due to fluctuations in environmental conditions such as temperature and humidity.

The gap can instead be sealed by applying an elastomeric sheet over it and adhering the sheet to both the inserted structural element and to appropriate locations on the wall or surrounding building framing members. These elastomeric sheets need to be strong enough to resist damage during installation. They also must be able to accommodate movement of the building framing members and/or inserted structural element that occurs during the life of the building. This movement can result from factors such as thermal expansion and contraction, settling of the building and/or the underlying ground; seismic events and percussive and/or acoustic events. In some cases, this movement can be quite significant. Additionally, the seal must remain intact over quite long periods of time while exposed to environmental stresses including high and low temperatures, water, snow and ice, ultraviolet radiation, and insects and other pests. These needs require the elastomeric sheet material to be rather robust and fabricated from resins based on silicone, polyolefin, polyurethane, and other polymer backbones. Thinner, lower performance films such as flashing tapes and housewraps typically do not have the necessary mechanical properties and long-term durability required for this service.

Being designed with these mechanical and durability concerns in mind, the elastomeric sheets have proven to be difficult to lay down uniformly, especially at corners, where they are folded over themselves or overlapped. It is difficult to obtain a good seal at the point of overlap when the elastomeric sheet has the thickness, mechanical properties and durability required in this application.

PCT/US2023/018623 describes an approach to resolving the problem of sealing at the point of overlap by providing a self-adhering barrier sheet featuring tapering of one or both of two opposing edges of the sheet. Two problems remain, however. One is a problem of efficient and cost-effective manufacturing. PCT/US2023/018623 describes several techniques for producing rolls of continuous elastomeric sheet with tapered edges, including cutting methods, casting and molding techniques, and profile sheet extrusion using specially shaped slot dies; however, the molding and extrusion methods are expensive, slow and inflexible. The other problem is that although the barrier sheet of PCT/US/2023/018623 is useful for solving the problem of reducing gaps at corner overlaps where the angle between the sheets is approximately 90 degrees, it is less effective for eliminating gaps that are produced at colinear overlap or splice joints. Further improvements are therefore desirable.

U.S. Pat. No. 4,806,400 describes forming a tape with tapered edges useful for wrapping underground piping to prevent corrosion. A knife and roller assembly is used to perform continuous cutting along a lateral edge of the tape. The roller has spaced grooves, each associated with a knife. The knife edge extends into the associated groove, pushing the tape into the groove and distorting it as it is slit so that shearing and drawing occur simultaneously. The angle of the taper so cut is different from the angle the knife makes to the roller when this apparatus is used to form tapered edges on a non-elastomeric polyethylene sheet.

### BRIEF SUMMARY OF THE INVENTION

In one aspect, this invention is a method for making a tapered edge in a nonporous elastomeric sheet having a thickness of 0.8 to 2.5 mm, comprising cutting a nonporous elastomer sheet with a blade at an angle of cutting of 15 degrees or less between the plane of the sheet and the blade, wherein the cutting is performed along a cut line with a blade oriented to the nonporous elastomeric sheet at the angle of cutting, while supporting the nonporous elastomeric sheet to prevent distortion of the nonporous elastomeric sheet at the cut line due to pressure of the blade against the nonporous elastomeric sheet.

This invention offers several advantages. Precise, sharply-angled tapered edges can be produced. Unlike extrusion processes, this process is easily adaptable to making barrier sheets having 3 or 4 or even more tapered edges. The extrusion process is easily adapted to produce tapered edges along the longitudinal, machine direction edges, but does not produce tapered transverse edges. Additionally, unlike extrusion processes, which produce sheets having fixed and unvarying widths based on the dimensions of the extrusion die, this process is easily adaptable to produce sheets of arbitrary width and length. Also, the process of the invention can be carried out partially or entirely in the field at a construction jobsite, allowing the barrier material to be cut to length and/or width as needed for a specific application.

The invention in a second aspect is a polygonal barrier sheet comprising a nonporous elastomeric sheet having a glass transition temperature of no greater than −40° C., the nonporous elastomeric sheet having a central region having a thickness of 0.8 to 2.5 mm, the central region being bounded by edges that include at least one pair of adjacent edges wherein each of the pair of adjacent edges is tapered to form an included angle of no greater than 15 degrees in each of said adjacent edges.

An important advantage of the polygonal barrier sheet of the invention is that it is well-adapted to form both cross-joints and splice joints, with good sealing at the joints.

The invention is also method of sealing a gap between adjacent members in a building construction, comprising applying and adhering a polygonal barrier sheet of the second aspect of the invention to the adjacent building members to span the gap with the polygonal barrier sheet.

In a particular aspect, the invention is a method of sealing an open joint between a building structure and an insert positioned within an opening in the building structure, comprising:
applying a polygonal barrier sheet of the second aspect of the invention to the insert and the building structure to span the open joint with the polygonal barrier sheet, whereby one of the tapered edges of the polygonal barrier sheet is adhered to the insert by means of an adhesive applied to said one of the opposing tapered edges and an opposing tapered edge of the polygonal barrier sheet is adhered to the building structure by means of an adhesive applied to said other opposing tapered edge.

The method of the invention has advantages of easy and inexpensive installation. The polygonal barrier sheets are simply cut to length and applied. A pressure sensitive adhesive may be pre-applied to the polygonal barrier sheet to facilitate application or, if desired, applied on-site at the point of application. Good sealing at both overlap and splice joints can be obtained.

This invention provides a further, significant advantage in installations in which wherein separate sections of the self-adhering barrier sheet are applied and overlap at an angle, with an overlapping section of a first self-adhering barrier sheet being applied onto an overlapped section of a second self-adhering barrier sheet by crossing over at least one tapered edge of the overlapped section. The tapered edge of the overlapped self-adhering barrier sheet allows for the minimization or elimination of a gap along the line of intersection of the two barrier sheets, allowing for a tight seal with reduced or no leakage, and without the need to separately seal that intersection. The flexible sheet, having a thicker, central section, retains the mechanical properties and durability required of these sealing products. Tapered edges also facilitate good seals about overlap joints and splice joints.

### BRIEF DESCRIPTION OF THE DRAWINGS

FIG. 1 is a top view of an embodiment of a polygonal barrier sheet of the invention.

FIG. 2A is a side cross-sectional view taken along arrows 2A of FIG. 1.

FIG. 2B is a side sectional view of an alternative embodiment of the polygonal barrier sheet of the invention.

FIG. 3A is a sectional view taken along arrows 3A of FIG. 1.

FIG. 3B is a side sectional view of an alternative embodiment of the polygonal barrier sheet of the invention.

FIG. 4 is a side sectional view of a polygonal barrier sheet of the invention, having an attached adhesive layer.

FIG. 4A is another sectional view of the polygonal barrier sheet of FIG. 4.

FIG. 5 is a sectional view illustrating an embodiment of a cutting process of the invention.

FIG. 5A is a sectional view illustrating another embodiment of a cutting process of the invention.

FIG. 6 is a perspective view of an embodiment of a cutting process of the invention as shown in FIG. 5.

FIG. 7 is a perspective view of another embodiment of a cutting process of the invention.

FIG. 8 is a top view of a building construction in which gaps between adjacent building members are sealed with polygonal barrier sheets of the invention that form an overlap joint.

FIG. 8A is a sectional view of the overlap joint shown, taken along arrows 8A in FIG. 8.

FIG. 9 is a sectional view of a colinear overlap joint formed with a polygonal barrier sheet of the invention and a second, overlapping barrier sheet.

FIG. 10 is a top view of a building construction in which a gap between adjacent building members is sealed with polygonal barrier sheets of the invention that form a splice joint.

FIG. 10A is a sectional view of the splice joint shown, taken along arrows 10A in FIG. 10.

### DETAILED DESCRIPTION OF THE INVENTION

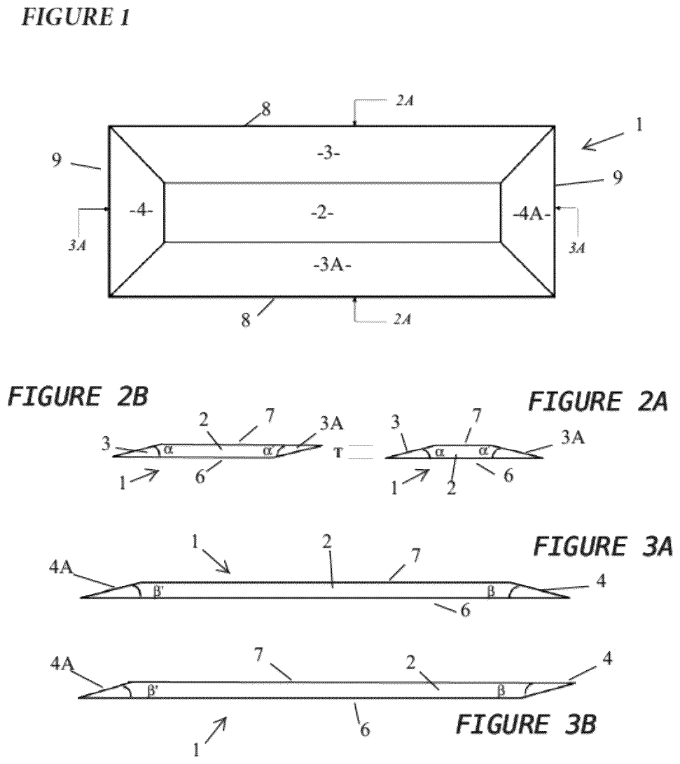

Turning to FIGS. 1, 2A and 2B, polygonal barrier sheet 1 includes central region 2 having a thickness T. T is 0.8 to 2.5 mm, preferably at least 1.0 mm or 1.25 mm and preferably up to 2.0 mm or up to 1.75 mm. As shown, central region 2 is bounded by opposing lateral edges 3 and 3A and opposing terminal edges 4 and 4A. Lateral edges 3 and 3A are adjacent to both of terminal edges 4 and 4A. In the particular embodiment shown in FIG. 1, both lateral edges 3 and 3A and both terminal edges 4 and 4A are tapered, as shown in FIGS. 2A and 3A. It is also within the scope of the invention for only one pair of adjacent edges to be tapered. For example, only one of lateral edges 3 and 3A and only one of terminal edges 4 and 4A may be tapered. Edges 3, 3A, 4 and 4A are straight in the embodiment shown in FIG. 1, but any or all of these may be curved instead.

Polygonal barrier sheet 1 as shown in FIG. 1 is quadrilateral (specifically rectangular) in shape, but need not be. Polygonal barrier sheet 1 may instead have any arbitrary number of edges, such as 3, 4, 5, 6, 7, 8 or more edges. Angles formed by adjacent edges of the polygonal barrier sheet may vary from 90° by any arbitrary amount as may be needed for a particular application, even in the case when polygonal barrier sheet 1 is quadrilateral. It is generally preferred that the polygonal barrier sheet has a pair of opposing edges that are not adjacent to each other. The opposing edges in some embodiments such as shown in FIGS. 1-4A include a pair of lateral edges that are parallel to each other, and a pair of terminal edges each of which is adjacent to at least one lateral edge. The terminal edges may or may not be parallel to each other, as may be needed or desirable for a particular application. For example, when used to seal certain inserts that may be round, pentagonal or otherwise different from rectangular in shape, the terminal edges may be cut at different angles to facilitate the formation of overlap and/or splice joints between different pieces of polygonal barrier sheet positioned around the insert.

As shown in FIG. 2A, lateral edges 3 and 3A are tapered, having included angles α and α′, respectively. α and α′ may be the same (as shown) or different. Each is at most 15 degrees and is preferably 5 to 12 degrees.

In FIG. 2A, lateral edges 3 and 3A are each tapered inwardly from bottom side 6 towards top side 7, producing a trapezoidal cross-section. In an alternative embodiment shown in FIG. 2B, lateral edge 3 tapers inwardly whereas lateral edge 3A tapers outwardly from bottom side 6 towards top side 7, producing a rhombic cross-section.

In another embodiment (not shown), lateral edges 3 and 3A are each tapered outwardly.

As shown in FIG. 3A, terminal edges 4 and 4A each are tapered inwardly, having included angles β and β′, respectively, producing a trapezoidal cross-section. β and β′ may be the same (as shown) or different. Each is at most 15 degrees and is preferably 5 to 12 degrees. In an alternative embodiment shown in FIG. 3B, lateral edge 4A is tapered inwardly from bottom side 6 to top side 7, and lateral edge 4 is tapered outwardly from bottom side 6 to top side 7, to produce a rhombic cross-section. Both terminal edges 4 and 4A may be tapered outwardly if desired.

The width of lateral tapered edges 3 and 3A and terminal tapered edges 4 and 4A each may be, for example, 1 to 25 mm or more. In some embodiments, the width of lateral tapered edges 3 and 3A and terminal tapered edges 4 and 4A each is at least 3 mm or at least 5 mm, and up to 20 mm or up to 15 mm.

The thickness of polygonal barrier sheet 1 at the outer termini 8 of tapered lateral edges 3 and 3A and outer termini 9 of tapered terminal edges 4 and 4A (see, e.g., FIG. 1) is as small as practical, preferably being no greater than 0.1 mm, no greater than 0.05 or no greater than 0.01 mm.

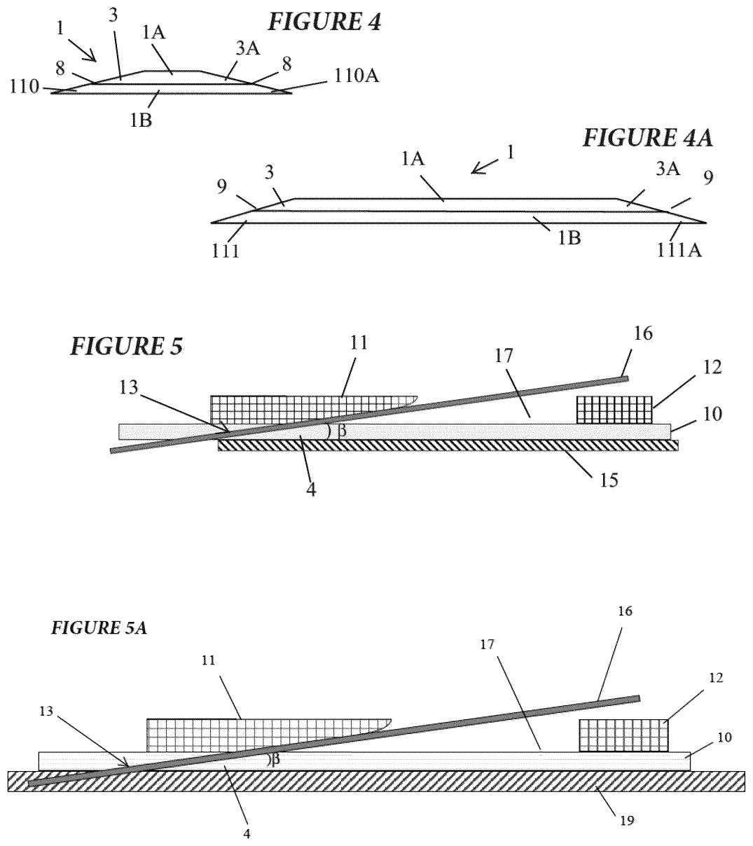

As shown in FIGS. 1 through 3B, polygonal barrier sheet 1 consists of a single layer of a nonporous elastomeric material as described more fully below. In alternative embodiments such as shown in FIGS. 4A and 4B, polygonal barrier sheet 1 comprises nonporous elastomeric sheet and further additionally comprises adhesive layer 1B. As shown in FIGS. 4A and 4B, lateral edges 110 and 110A and/or terminal edges 111 and 111A of adhesive layer 1B are optionally tapered in the same manner as lateral tapered edges 3 and 3A and terminal tapered edges 4 and 4A of nonporous elastomeric sheet 1A. Such an embodiment can be produced by, for example, first applying adhesive layer 1B to nonporous elastomeric sheet 1A, and simultaneously cutting one or more of the lateral and terminal edges of both adhesive layer 1B and nonporous elastomeric sheet 1A to produce the desired tapering.

Alternatively, adhesive layer 1B may not be tapered, in that case preferably extending at most to outer termini 8 of lateral tapered edge 4 and 4A and at most to outer termini 9 of terminal tapered edges 3 and 3A. Adhesive layer 1B may be discontinuous and may not cover the entire major surface of nonporous elastomeric sheet 1A. For example, adhesive layer 1B may be applied only to lateral tapered edges 4 and 4A and/or terminal tapered edges 3 and 3A. Adhesive layer 1B is shown in FIGS. 4 and 4A as being applied to a bottom side of layer 1A of the nonporous elastomeric sheet 1A; in other embodiments, Adhesive layer 1B may be instead or in addition applied to the top major surface of nonporous elastomeric sheet 1A, and as before may be discontinuous or continuous, and may be applied only to the lateral and/or terminal tapered edges. Lateral and/or terminal edges of any adhesive layer 1B applied onto the top side of nonporous elastomer sheet 1A may or may not be tapered in the same manner as nonporous elastomeric sheet 1A.

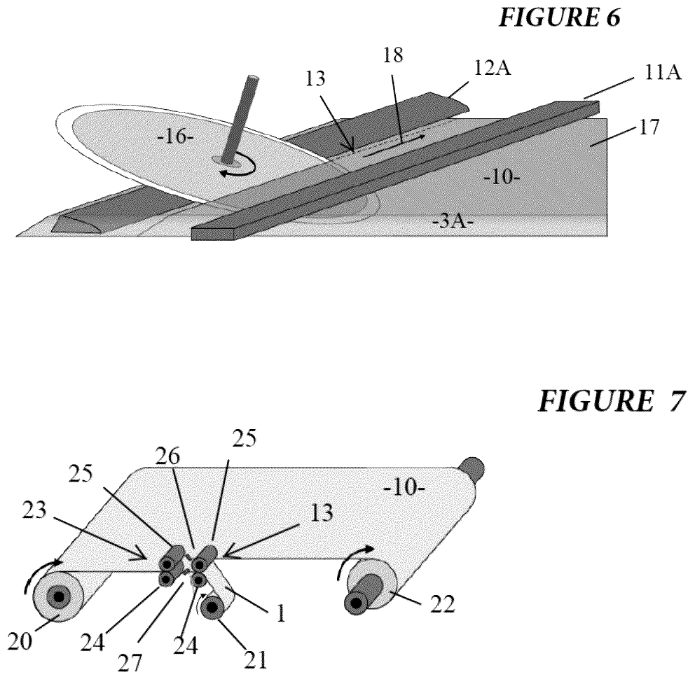

At least one tapered edge of the nonporous elastomeric sheet is made by cutting the sheet at an angle of cutting of 15 degrees or less. The cutting step is performed along a cut line with a blade oriented to the nonporous elastomeric sheet at the angle of cutting. Cut lines may be straight or curved. The nonporous elastomeric sheet is supported to prevent distortion of the nonporous elastomeric sheet at the cut line due to action of the blade against the nonporous elastomeric sheet. The nonporous elastomeric sheet preferably is supported from below and in addition from above during the cutting step. The nonporous elastomeric sheet preferably is supported from above on each side of the cut line, as well as being supported from below, as shown in FIGS. 5 and 6.

In FIGS. 5 and 6, nonporous elastomeric sheet 10 is cut along cut line 13 with blade 16 to produce tapered terminal edge 4 having included angle β. Nonporous elastomeric sheet 10 is supported from below by lower support 15 (FIG. 5), which may be, for example, a tabletop, benchtop or any other rigid surface. As shown in FIG. 5, lower support 15 extends closely to cut line 13. A second lower support (not shown) may be provided on the opposing (left, as shown) side of blade 16 and cut line 13.

In the particular embodiment shown in FIG. 5A, upper supports 11 and 12 are positioned in contact with upper surface 17 of the nonporous elastomeric sheet 10, on either side of blade 16 and cut line 13. Supports 11 and 12 hold nonporous elastomeric sheet 10 against lower support 15, proximate to cut line 13, and in that way reduce movement of elastomeric sheet 10 as it is cut by blade 16, thereby preventing nonporous elastomeric sheet from becoming distorted as it is cut. This ensures a clean and accurate cut at the defined angle.

As shown in FIGS. 5 and 6, upper supports 11 and 12 (FIG. 5) and upper supports 11A and 12A (FIG. 6) take the form of stabilizer bars that extend across nonporous elastomeric sheet 10 in the direction of cutting (as indicated by arrow 18 in FIG. 6). Either or both of upper supports 11 and 12 (or 11A and 12A) may include an angled surface which functions as a guide for blade 16, establishing the angle of blade 16 to nonporous elastomeric sheet 10 so as to produce included angle β of tapered edge 4. In the particular embodiments shown in FIGS. 5 and 5A, only upper support 11 has such an angled surface. In the alternative embodiment shown in FIG. 6, only upper support 12A has such an angled surface. In either embodiment, both upper supports may have such angled surfaces. Blade 16 is aligned with the angled surface(s) of the upper support(s). Blade 16 is shown as a circular rotary blade in FIG. 6, but may be a straight blade, if desired.

In embodiments such as shown in FIG. 5A, blade 16 may extend through nonporous elastomeric sheet 10, into and partially or entirely through a replaceable, sacrificial layer 19, as shown in FIG. 5A, partially or entirely cutting sacrificial layer 19 as nonporous elastomeric sheet 10 is cut. This configuration is especially useful for making tapered terminal edge cuts in the field, where sacrificial layer 19 can be a rubber cutting mat, scrap wood board, or even cardboard. Sacrificial layer 19 supports nonporous elastomeric sheet 10 from below to prevent distortion at the cut line due to the pressure of blade 16 against nonporous elastomeric sheet 10. Upper supports 11 and 12 support nonporous elastomeric sheet 10 from above to further prevent such distortion.

Upper supports disposed on either side of the cutting blade may be connected at their ends to form a stabilizer assembly in which the distance between the upper supports is fixed.

In the embodiment shown in FIG. 6, nonporous elastomeric sheet 10 already has tapered lateral edge 3A, and cutting along cut line 13 produces a tapered terminal edge. In some embodiments, tapered lateral edges are produced in an extrusion process, leaving only tapered terminal edges to be produced by cutting. This allows the elastomeric sheet with tapered lateral edges to be produced continuously with fixed widths and indeterminate lengths, which can be sold as rollstock. The cutting step to produce tapered terminal edges then can be performed on-site, to cut the sheet to any arbitrary length as may be required, and to produce an inwardly or outwardly tapered terminal edge, as may be needed.

In alternative embodiments, all tapered edges are produced by cutting. Tapered lateral edges 3 and 3A can be produced by cutting a “mother roll” of a wide sheet of nonporous elastomeric sheet, using a stationary slitter with its blade set at an angle α to the staring nonporous elastomeric sheet. Cutting is performed by moving the sheet past the stationary slitter. An embodiment of such a process is shown in FIG. 7.

In FIG. 7, nonporous elastomeric sheet 10 is fed from mother roll 20 and pulled past slitter apparatus 23 by powered roller 22 or other apparatus such as a tentering frame for moving nonporous elastomeric sheet 10. Slitter apparatus 23 includes bottom rollers 24, which provide support for nonporous elastomeric sheet 10 from beneath proximate to the cut lines, and upper rollers 25, which provide support for nonporous elastomeric sheet 10 from above proximate to the cut lines. Nonporous elastomeric sheet 10 passes between bottom rollers 24 and upper rollers 25, each of which is in contact with a lower (bottom rollers 24) or top (upper rollers 25) surface of nonporous elastomeric sheet 10. Slitter apparatus 23 further includes blades 26 and 27, each of which is disposed between the two bottom rollers 24 and the two upper rollers 25, and each of which is disposed at an angle α to nonporous elastomeric sheet 10. Slitter apparatus 23 is stationary. Nonporous elastomeric sheet 10 is cut into a polygonal barrier sheet 1 having tapered lateral edges, the tapered lateral edges having an included angle α. If desired, multiple slitter apparati 23 can be provided to simultaneously cut a wide nonporous elastomeric sheet 10 into multiple polygonal barrier sheets 1 into various widths as needed. Tapered terminal edges then can be produced by cutting discrete pieces or sections from such a roll, for example as described in FIGS. 5, 5A and 6.

In a particular embodiment, the cutting process is used to produce polygonal barrier sheets having greater than four sides. A quadrilateral nonporous elastomeric sheet having tapered lateral edges and terminal edges that are also optionally tapered is produced. The tapered lateral edges may be produced in any convenient way, including by extruding the nonporous elastomeric sheet with tapered lateral, cutting as described herein, or other convenient way. Tapered terminal edges, when present, preferably are produced by cutting as described herein. The quadrilateral nonporous elastomeric sheet is cut one or more times with a blade at an angle of cutting of 15 degrees or less between the plane of the sheet and the blade to produce additional tapered edges, forming a polygonal sheet having greater than four sides, where all sides have tapered edges having an included angle of 15 degrees or less.

By “nonporous”, it is meant that the elastomer sheet contains no pores at all or, if it contains pores, those pores are not interconnected to produce fluid paths from one major side of the nonporous elastomer sheet to the other. The nonporous elastomeric sheet should be a barrier to liquid water, preferably passing the water tightness test of EN1928:2000 Method B without leakage under conditions of 0.3 kPa pressure for at least 30 minutes. The material of construction for the nonporous elastomeric sheet is preferably a polymer, which may be thermoplastic or thermoset. The nonporous elastomeric sheet preferably has an elongation to maximum load of at least 10%, preferably at least 50% or at least 100%, as measured by ASTM D412. In especially preferred embodiments, the nonporous elastomeric sheet exhibits a Shore A hardness of at least 20 and at most 80 or at most 60 (ASTM D2240-15). Examples of suitable materials of construction for the nonporous elastomeric sheet include elastomeric materials such as silicone rubber, polyurethane rubber, polyester rubber, polyamide rubber, thermoplastic vulcanizate, polyolefin rubber, polymers and copolymers of diene monomers such as butadiene, isoprene and chloroprene (including styrene/butadiene deblock and triblock copolymers), nitrile rubbers and natural rubber. The nonporous elastomeric sheet may be a single layer material, a composite material, or a multilayer coextruded or laminated material.

The polygonal barrier sheet of the invention is useful for sealing a gap between adjacent members in a building construction. The gap is sealed by applying and adhering a polygonal barrier sheet of the invention to the adjacent members to span the gap with the self-adhering barrier sheet. Typically, a lateral edge, usually a tapered lateral edge, of the polygonal barrier sheet is adhered to a first building member which is adjacent to the gap. Another edge, usually a tapered opposing lateral edge, of the polygonal barrier sheet is adhered to the other adjacent member such that the polygonal barrier sheet spans and covers the gap. Methods of using a barrier sheet having tapered edges to seal gaps in building constructions are described in more detail in PCT/US2023/018623, incorporated herein by reference; such methods are applicable herein.

The tapered edges facilitate good sealing when separate polygonal barrier sheets are overlapped to produce an overlap joint or connected at a splice joint.

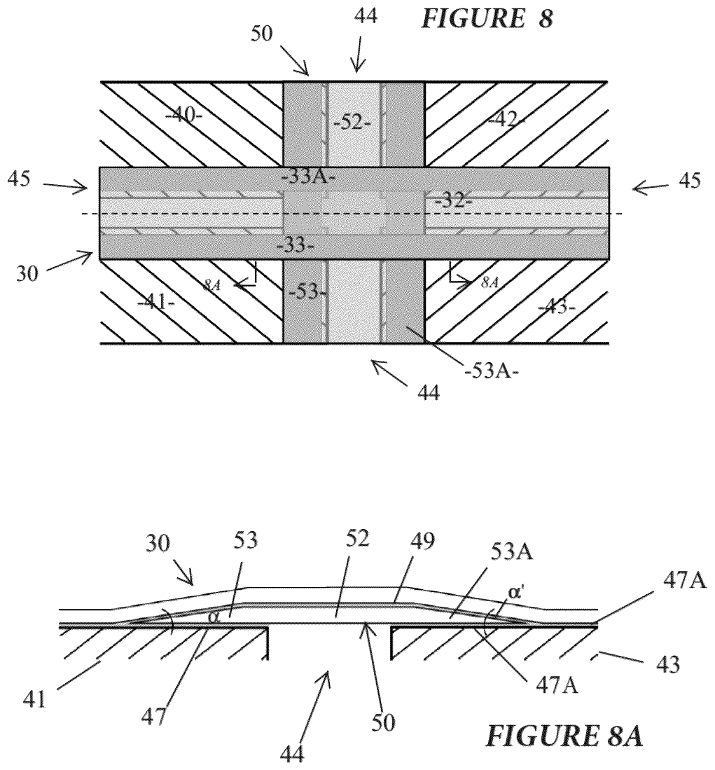

FIGS. 8 and 8A illustrate an exemplary embodiment of sealing crossing gaps with two polygonal barrier sheets that form an overlap joint. Building members 40, 41, 42 and 43 are arranged so as to produce horizontal gap 45, which resides between building members 40 and 41 and between building members 42 and 43, and vertical gap 44, which resides between building members 40 and 42 and between building members 41 and 43.

Polygonal barrier sheet 50 includes central portion 52 and opposing tapered lateral edges 53 and 53A. Tapered lateral edge 53 is adhered to building members 40 and 41 via adhesive layer 47. Tapered lateral edge 53A is adhered to building members 42 and 43 via adhesive layer 47A. Central portion 52 spans gap 44.

Polygonal barrier sheet 30 includes central portion 32 and opposing tapered lateral edges 33 and 33A. Tapered lateral edge 33 is adhered to building members 41 and 43 via an adhesive layer (not shown). Tapered lateral edge 33A is adhered to building members 40 and 42 via an adhesive layer (not shown). Central portion 32 spans gap 45.

An overlapping portion of polygonal barrier sheet 30 overlaps polygonal barrier sheet 50 to produce an overlap joint. Polygonal barrier sheet 30 crosses tapered lateral edge 53, central portion 52 and tapered lateral edge 53A, being adhered thereto by adhesive layer 49. As can be seen in FIG. 8A, the presence of tapered edges 53 and 53A in the overlapped portion of polygonal barrier sheet 50 eliminates gaps at the termini of tapered lateral edges 53 and 53A, improving the seal, as described more fully in PCT/US2023/018623.

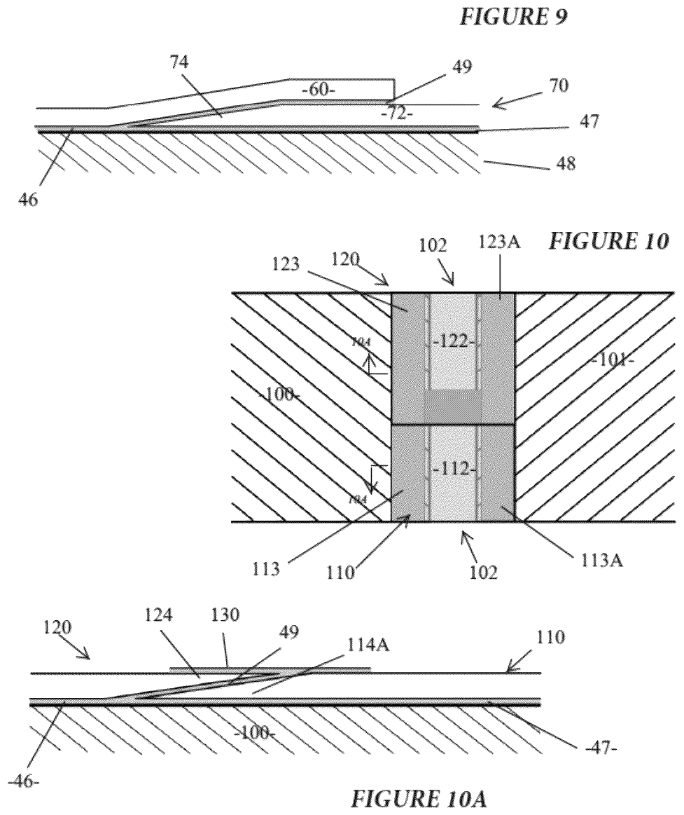

FIG. 9 shows a co-linear overlap joint made with a polygonal barrier sheet 70 of the invention that has tapered terminal edge 74, and a second barrier sheet 60 which in this case has a blunt terminal edge (i.e., a terminal edge having no tapering). Polygonal barrier sheet 70 includes central portion 72, which has tapered lateral edges (not shown) and tapered terminal edge 74. Polygonal barrier sheet 70 is adhered to building member 48 via adhesive layer 47. Second barrier sheet 60 is adhered to building member 48 via adhesive layer 46. Second barrier sheet 60 overlaps tapered terminal edge 74 and a portion of central portion 72 of polygonal barrier sheet 70, being adhered thereto via adhesive layer 49. Gaps at the point where second barrier sheet 60 intersects with polygonal barrier sheet 70 are eliminated due to the tapering of tapered terminal edge 74.

FIGS. 10 and 10A illustrate the use of polygonal barrier sheets of the invention to produce a splice joint. Building members 100 and 101 are arranged to produce gap 102. First polygonal barrier sheet of the invention 110 has central portion 112, opposing tapered lateral edges 113 and 113A, and inwardly tapered terminal edge 114A. Tapered lateral edges 113 and 113A are adhered to building members 100 and 101, respectively, via an adhesive layer such as adhesive layer 47 (FIG. 10A). Central portion 112 of first polygonal barrier sheet 110 spans and covers a portion of gap 102.

Second polygonal barrier sheet of the invention 120 has central portion 122, opposing tapered lateral edges 123 and 123A, and outwardly tapered terminal edge 124. Tapered lateral edges 123 and 123A are adhered to building members 100 and 101, respectively, via an adhesive layer such as adhesive layer 46 (FIG. 10A). Central portion 122 of second polygonal barrier sheet 120 also spans and covers a portion of gap 102.

Outwardly tapered terminal edge 124 of second polygonal barrier sheet 120 overlaps inwardly tapered terminal edge 114A of first polygonal barrier sheet 110 to produce a splice joint. Adhesive layer 49 adheres outwardly tapered terminal edge 124 to inwardly tapered terminal edge 114A. In the embodiment shown in FIG. 10A, optional additional adhesive 130 is applied to the exposed surfaces of first and second polygonal barrier sheets 110 and 120 in the region of the splice joint. A splice joint so produced provides a flat exterior surface, unlike the colinear overlap joint of FIG. 9.

A gap to be sealed in accordance with the invention may be defined by, for example, any two adjacent members of a building structure itself which are spaced part, such as: i) a gap between framing members (such as studs, floor, ceiling or roofing joints, or trusses); ii) a gap between walls or other partition sections; iii) a gap between floor or roof sections; iv) a gap between a wall or other partition and a floor or roof. The geometrical shape of the gap is not critical so long as the gap can be spanned with the elastomeric barrier sheet. The self-adhering barrier sheet is particularly suitable for sealing gaps having a width of 1 to 500 mm, especially 25 to 300 mm or 50 to 300 mm.

Materials of construction of the building structure are not limited, so long as the adhesive can form an adhesive bond thereto. The portions of the building construction to which the self-adhering barrier sheet can be applied may be, for example, metals such as aluminum, steel, copper; natural stone such as granite, marble, limestone and slate; cementitious material such as concrete, cinder blocks and mortar; cast materials such as brick and ceramic tile; fabricated products such as gypsum board; laminated insulating panels; wood products such as wood, plywood and oriented strand board; artificial wood products; dense and/or foamed polymer products such as vinyl siding and insulation board; among others. Any of these materials of construction may be coated by, for example, paint or another coating, such as a primer to promote adhesion, or with a film (such as a moisture barrier or other protective film).

In some embodiments, the elastomeric barrier sheet is used to seal a gap between building frame members and an insert positioned within an opening in the building frame members. Such an insert may be any structure that is inserted into a building structure for some functional, aesthetic or other purpose. Examples of other inserts include a window; a window frame; a door; a door frame; a lintel; a fan; an electrical panel; a vent; a chase for electrical, plumbing, HVAC or other conduits and/or cables; a mailbox or mail slot; an access panel; a frame or holder for a decorative element; among others. The insert may be rectangular or any other shape as may be useful for its particular purpose.

Gaps between inserts and building frame members are sealed in the same general manner as other gaps as described before. A lateral edge of the polygonal barrier sheet is adhered to the insert by means of an adhesive applied to said lateral edge and the opposing lateral edge of the polygonal barrier sheet is adhered to a building frame member by means of an adhesive applied to said opposing lateral edge. The lateral edges preferably are tapered in accordance with the invention to prevent gaps where the barrier sheets overlap. In certain embodiments the insert has multiple insert sides, each pair of adjacent multiple insert sides defining a vertex, and open joints are defined by each of said adjacent multiple insert sides and at least one side of the openings, and adjacent pairs of polygonal barrier sheet form overlap joints at the vertices. In alternative embodiments, the insert has multiple insert sides, each pair of adjacent multiple insert sides defining a vertex, and open joints are defined by each of said adjacent multiple insert sides and at least one side of the openings. Adjacent pairs of polygonal barrier sheet having tapered terminal edges can form angled splice joints at points where tapered terminal edges of adjacent polygonal barrier sheet overlap at the vertices.

The adhesive used to adhere the elastomeric barrier sheet preferably is a pressure sensitive type. Examples of pressure sensitive adhesives include silicone, acrylic, so-called “modified acrylic” and natural or synthetic rubber types. The adhesive is generally selected in conjunction with the choice of flexible sheet and/or the building members to which it will be applied. Suitable pressure sensitive adhesive products are widely available from sources such as 3M, Adhesive Applications, Dow Chemical, Elkem Silicones, Lohmann GmbH & Co., and Sika Services AG. The adhesive may be applied directly to the polygonal barrier sheet or provided in the form of a tape which is applied to a portion or the entire surface of the polygonal barrier sheet. In particular embodiments, the adhesive is in the form of a double-sided tape that has two layers of pressure sensitive adhesive coated onto either side of a carrier film. The two layers of pressure sensitive adhesive may be the same or different; for example, one layer of pressure sensitive adhesive may be selected for its bonding properties to the polygonal barrier sheet whereas the other layer may be selected for its bonding properties to members of the building construction. In a particular embodiment, one layer of pressure sensitive adhesive may be a silicone or “modified acrylic” type for bonding to a silicone polygonal barrier sheet, and the other layer may be a general-purpose acrylic or natural or synthetic rubber type for bonding to the building construction.

Alternatively, the adhesive may be applied to a surface of the polygonal barrier sheet in liquid form as a solution or as a melt that is subsequently solidified.

The thickness of the adhesive layer preferably is no greater than the maximum thickness of the polygonal barrier sheet and is preferably no greater than 50% or no greater than 10% thereof. In absolute terms, the thickness of an adhesive layer may be, for example 0.01 to 0.75 mm, preferably 0.05 to 0.5 mm or 0.05 to 0.1 mm.

An adhesive layer applied to the polygonal barrier material prior to use may be covered with protective film for purposes of packaging, storage and/or transportation. The protective film is removed to expose the adhesive prior to installation.

Wall assemblies utilizing the barrier sheets of this invention preferably pass ASTM E2357: Standard Test Method for Determining Air Leakage Rate of Air Barrier Assemblies” and/or ASTM D331-00 (Standard Test Method for Water Penetration for Exterior Windows, Skylights, Doors and Curtain Walls by Uniform Static Air Pressure Difference”. As specified in SM E83: Standard Test Method for Determining Rate of Air Leakage Through Exterior Windows, Curtain Walls, and Doors Under Specified Pressure Differences Across the Specimen, such an assembly qualifies as an air barrier assembly, both for air infiltration and exfiltration, if it meets the air passage criteria of less than 0.04 cfm/sqft infiltration/exfiltration at 1.57 psf air pressure.

What is claimed is:

1. A method for making a tapered edge in a nonporous elastomeric sheet having a thickness of 0.8 to 2.5 mm, comprising cutting a nonporous elastomer sheet with a blade at an angle of cutting of 15 degrees or less between the plane of the sheet and the blade, wherein the cutting is performed along a cut line with a blade oriented to the nonporous elastomeric sheet at the angle of cutting, while supporting the nonporous elastomeric sheet to prevent distortion of the nonporous elastomeric sheet at the cut line due to pressure of the blade against the nonporous elastomeric sheet.

2. The method of claim 1 wherein the nonporous elastomeric sheet is supported from above and below during the cutting.

3. The method of claim 1 wherein the nonporous elastomeric sheet is supported on opposite sides of the blade proximate to the cut line during the cutting.

4. The method of claim 1 wherein the nonporous elastomeric sheet is supported with a stabilizer bar applied to a top surface of the nonporous elastomeric sheet proximate to the cut line.

5. The method of claim 1 wherein the nonporous elastomeric sheet is supported with two stabilizer bars applied to the top surface of the nonporous elastomeric sheet on opposite sides of the blade proximate to the cut line.

6. The method of claim 5 wherein at least one stabilizer bar has an angled surface that defines the angle of cutting, and the blade is aligned at the angle of cutting by contact with said angled surface of said stabilizer bar.

7. The method of claim 1 wherein the nonporous elastomeric sheet is supported from below by a sacrificial layer, and the blade cuts the sacrificial layer and the nonporous elastomeric layer along the cut line at the angle of cutting.

8. The method of claim 1 wherein the nonporous elastomeric sheet is a quadrilateral having a central region having a thickness of 0.8 to 2.5 mm, the central region being bounded by a pair of opposing lateral edges and a pair of opposing terminal edges, and each pair of opposing lateral edges is tapered by moving the nonporous elastomeric sheet past a stationary blade to produce a nonporous elastomeric sheet having tapered lateral edges having included angles of 15 degrees or less.

9. The method of claim 8 wherein the stationary blade is mounted onto a slitter apparatus that further includes bottom rollers which provide support from beneath the nonporous elastomeric sheet proximate to the cut line, and upper rollers that provide support from above the nonporous elastomeric sheet proximate to the cut line.

10. The method of claim 8 wherein the nonporous elastomeric sheet is in the form of a wide mother roll, and the mother roll is moved past multiple stationary blades to produce multiple strips of nonporous elastomeric sheet having tapered lateral edges.

11. The method of claim 8 wherein at least one of the pair of opposing terminal edges of the nonporous elastomeric sheet having tapered lateral edges is subsequently cut to form a tapered terminal edge having an included angle of 15 degrees or less.

12. The method of claim 1 wherein the nonporous elastomeric sheet is a quadrilateral having tapered lateral edges and optionally tapered terminal edges, and the quadrilateral nonporous elastomeric sheet is cut one or more times with a blade at an angle of cutting of 15 degrees or less between the plane of the sheet and the blade to produce a polygonal sheet having greater than four sides, where all sides have tapered edges having an included angle of 15 degrees or less.

13. The method of claim 1 wherein the nonporous elastomeric sheet is composed of a crosslinked silicone rubber, a crosslinked polyolefin rubber, or a crosslinked polyurethane rubber.

14. The method of claim 1 wherein an adhesive layer is present on at least a portion of one major surface of the nonporous elastomeric sheet prior to the cutting step.

15. The method of claim 1 further comprising applying an adhesive layer to at least one tapered edge after the cutting step.

16. A polygonal barrier sheet comprising a nonporous elastomeric sheet of a polymer having a glass transition temperature of no greater than −40° C., the nonporous elastomeric sheet having a central region having a thickness of 0.8 to 2.5 mm, the central region being bounded by edges that include at least one pair of adjacent edges wherein each of the pair of adjacent edges is tapered to form an included angle of no greater than 15 degrees in each of said adjacent edges.

17. The polygonal barrier sheet of claim 16 wherein the central region is bounded by a pair of opposing lateral edges and a pair of opposing terminal edges, wherein at least one lateral edge and at least one terminal edge are tapered to form an included angle of no greater than 15 degrees in each of said at least one lateral edge and at least one terminal edge.

18. The polygonal barrier sheet of claim 17 wherein both opposing lateral edges are tapered to form included angles of no greater than 15 degrees.

19. The polygonal barrier sheet of claim 18 wherein the included angle of the tapered terminal edge and the included angles of the tapered lateral edges are no greater than 10 degrees.

20. The polygonal barrier sheet of claim 16 further comprising an adhesive layer applied to at least one side of each of the tapered edges, the adhesive layer having a thickness no greater than the thickness of the central region of the nonporous elastomeric sheet.

21. A method of sealing a gap between adjacent members in a building construction, comprising applying and adhering a polygonal barrier sheet of claim 16 to the adjacent members to span the gap with the self-adhering barrier sheet.

22. The method of claim 21 wherein separate first and second polygonal barrier sheets are applied and adhered to the adjacent members such that the first and second polygonal barrier sheets are aligned and the tapered terminal edges of the first and second polygonal barrier sheets overlap to produce a splice joint.

23. A method of sealing a gap between adjacent members in a building construction, comprising applying and adhering a first and then a second polygonal barrier sheet of claim 16 to the adjacent members to span one or more gaps between the adjacent members such that the first and second polygonal barrier sheets overlap at an angle to produce an overlap joint, with an overlapping portion of the second polygonal barrier sheet being applied over an overlapped portion of the first polygonal barrier sheet by crossing the overlapping portion of the second polygonal barrier sheet over at least one tapered lateral edge of the overlapped portion of the first polygonal barrier sheet.

24. A method of sealing an open joint between a building structure and an insert positioned within an opening in the building structure, comprising:
applying a polygonal barrier sheet of claim 16 to the insert and the building structure to span the open joint with the polygonal barrier sheet, whereby a lateral edge of the polygonal barrier sheet is adhered to the insert by means of an adhesive and an opposing lateral edge of the polygonal barrier sheet is adhered to the building structure by means of an adhesive.

25. The method of claim 24 wherein the insert has multiple insert sides, each pair of adjacent multiple insert sides defining a vertex, and open joints are defined by each of said adjacent multiple insert sides and at least one side of the openings, separate polygonal barrier sheets are applied to seal each of the open joints, the lateral edges of each of the polygonal barrier sheets are tapered and adjacent pairs of the separate polygonal barrier sheet form overlap joints at the vertices.
